(19) United States
(12) Patent Application Publication
(10) Pub. No.: US 2018/0174577 A1
(43) Pub. Date: Jun. 21, 2018

(54) LINGUISTIC MODELING USING SETS OF BASE PHONETICS

(71) Applicant: Microsoft Technology Licensing, LLC, Redmond, WA (US)

(72) Inventors: Raghu Jothilingam, Madhapur (IN); Sanal Sundar, Chanda Nagar (IN)

(73) Assignee: Microsoft Technology Licensing, LLC, Redmond, WA (US)

(21) Appl. No.: 15/382,959

(22) Filed: Dec. 19, 2016

(51) Int. Cl. G10L 15/187; G10L 15/22; G10L 15/07

(52) U.S. Cl. CPC G10L 15/187; G10L 15/07; G10L 15/22

(57) ABSTRACT

An example system for linguistic modeling includes a processor and computer memory including instructions that cause the computer processor to receive a voice recording associated with a user. The instructions also cause the processor to extract base phonetics from the received voice recording to generate a set of base phonetics corresponding to the user. The instructions further cause the processor to interact with the user in a style or dialect of the user based on the set of base phonetics corresponding to the user.

### BACKGROUND

Devices may include voice playback that can read back text or respond to commands For example, devices may choose between multiple different voice models for playback in different languages.

### SUMMARY

The following presents a simplified summary of the innovation in order to provide a basic understanding of some aspects described herein. This summary is not an extensive overview of the disclosed subject matter. It is intended to neither identify key elements of the disclosed subject matter nor delineate the scope of the disclosed subject matter. Its sole purpose is to present some concepts of the disclosed subject matter in a simplified form as a prelude to the more detailed description that is presented later.

One implementation provides for a system for linguistic modeling. The system includes a computer memory and a processor to receive a voice recording associated with a user. The processor can also extract base phonetics from the received voice recording to generate a set of base phonetics corresponding to the user. The processor can further interact with the user in a style or dialect of the user based on the set of base phonetics corresponding to the user.

Another implementation provides a method for linguistic modeling. The method includes receiving a voice recording associated with a user. The method additionally includes extracting base phonetics from the received voice recording to generate a set of base phonetics corresponding to the user. The method further includes interacting with the user in a style or dialect of the user based on the set of base phonetics corresponding to the user.

Another implementation provides for one or more computer-readable memory storage devices for storing computer readable instructions that, when executed by one or more processing devices, instruct linguistic modeling. The computer-readable instructions may include code to receive a voice recording associated with a user. The computer-readable instructions may also include code to extract base phonetics from the received voice recording to generate a set of base phonetics corresponding to the user. The computer-readable instructions may also include code to interact with the user in a style or dialect of the user based on the set of base phonetics corresponding to the user.

The following description and the annexed drawings set forth in detail certain illustrative aspects of the disclosed subject matter. These aspects are indicative, however, of a few of the various ways in which the principles of the innovation may be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 is a block diagram of an example system for interacting in different languages using base phonetics;

FIG. 2 is an information flow diagram of an example system for providing one or more features using base phonetics;

FIG. 3 is an example configuration display for a linguistic modeling application;

FIG. 4 is an example daily routine input display of a linguistic modeling application;

FIG. 5 is an example voice recording display of a linguistic modeling application;

FIG. 6 is another example configuration display for a linguistic modeling application;

FIG. 7 is a process flow diagram of an example method for configuring a linguistic modeling program;

FIG. 8 is a process flow diagram of an example method for interaction between a device and a user using base phonetics;

FIG. 9 is a process flow diagram of an example method for translating language between users using base phonetics;

FIG. 10 is a process flow diagram of an example method for interaction between a user and a device using base phonetics and detected emotional states;

FIG. 11 is a block diagram of an example operating environment configured for implementing various aspects of the techniques described herein; and

FIG. 12 is a block diagram showing example computer-readable storage media that can store instructions for linguistic modeling using base phonetics.

### DETAILED DESCRIPTION

Currently, some devices are able to interact with users via voice detection. For example, a device may detect that a user has requested that a particular action be performed and confirm that the user wants the action performed before executing the action. In some examples, the devices may respond with a voice in a language that is understood by the user. For example, the voice may speak in English or Spanish, among other languages, for users in the United States.

However, languages may be composed of many different dialects that are spoken differently in various regions or cultures. For example, English spoken in the United States may vary by region with respect to accent and may be very different from English spoken in various parts of England or other English-speaking areas. Similarly, India has thousands of dialects based on Hindi alone that may make customizing software for each dialect difficult and time consuming. Moreover, even within each dialect, each person may further add a flavour to the dialect that they speak in that is unique to that person. Thus, users typically must interact with a device in language that may be different from their own dialect and personal style.

In addition, current language learning software provides exercises to individuals to learn a variety of languages. However, such software typically teaches one dialect of any particular language, and typically presents the same exercises and materials to everyone learning the language. For example, the language learning software may use language packs that limit the dynamism that needs to be applied while dealing with real-time linguistics. Moreover, learning languages via software may not enable users to be proficient in a language without practicing speaking with native speakers. However, some older languages may not have many native speakers with which to practice, if any at all.

Embodiments of the present techniques described herein provide a system, method, and computer-readable medium with instructions for linguistic modeling using base phonetics. As used herein, base phonetics refer to sounds of human speech. For example, a base phonetic may have one or more attributes including pitch, amplitude, timbre, harmonics, and one or more parameters including vibratory frequency, degree of separation of vocal folds, nasal influence, and modulation. Attributes, as used herein, may refer to one or more characteristics describing a voice. One or more parameters may be used to define and detect a particular attribute associated with a voice of an individual. In particular, an application may be used by devices to interact with users in their native language, dialect, and style, and allow users to interact with other users in their respective native language, dialect, and style. As used herein, style refers to a speaker's particular manner of speaking a language or dialect. For example, the application may extract base phonetics from voice recordings for each user to generate a set of base phonetics corresponding to each user. The application can then interact with each user in the native language and individual style of each user, or enable users to talk with one another in their respective native dialects via the application. For example, the application may be installed on mobile devices used by each user.

Advantageously, the present techniques may extract base phonetics over time to construct the style or dialect for a user, and thus does not use or need access to any large database of languages. In addition, the techniques described herein may be used to improve interaction between devices and users. For example, a device may be able to interact with a user in a dialect and manner similar to the user's voice. Moreover, the present techniques may enable users to emotionally connect with other users that may speak with different styles and expressions. The present techniques thus can also improve the ability of specially-abled individuals to interact with each other and others that are less specially-abled. For example, specially-abled individuals may include individuals with speech irregularities, including those due to expressive aphasias such as Broca's Aphasia. Additionally, the techniques may enable users to learn new languages in a more efficient manner by focusing on particular difficulties related to a user's specific lingual background and speaking style. For example, a learning plan for a particular language can be tailored for each individual user based on the set of base phonetics for the user. Moreover, the techniques may enable users to learn rare or extinct languages by providing a virtual native speaker to practice the language with when native speakers may be difficult, if not impossible, to find. Thus, the present techniques may also be used to revive rare languages that may otherwise be lost due to a lack of native speakers.

Moreover, the system may be usable without preexisting dictionaries corresponding to different dialects. For example, the system may learn a user's dialect and other speech patterns and emotions gradually over time. In some examples, the system may provide an option to interact with the user in different voices depending on the detected emotion of the user. In some examples, the system may be used to supplement a specially-abled person's voice input to present language that is more easily understandable by others.

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component. FIG. 16, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the disclosed subject matter may be implemented as a method, apparatus, or article of manufacture using standard programming and engineering techniques to produce software, firmware, hardware, or any combination thereof to control a computing device to implement the disclosed subject matter. The term “article of manufacture,” as used herein is intended to encompass a computer program accessible from any computer-readable storage device or media. Computer-readable storage media include magnetic storage devices, e.g., hard disk, floppy disk, magnetic strips, optical disk, compact disk (CD), digital versatile disk (DVD), smart cards, flash memory devices, among others. Moreover, computer-readable storage media does not include communication media such as transmission media for wireless signals. In contrast, computer-readable media, i.e., not storage media, may include communication media such as transmission media for wireless signals.

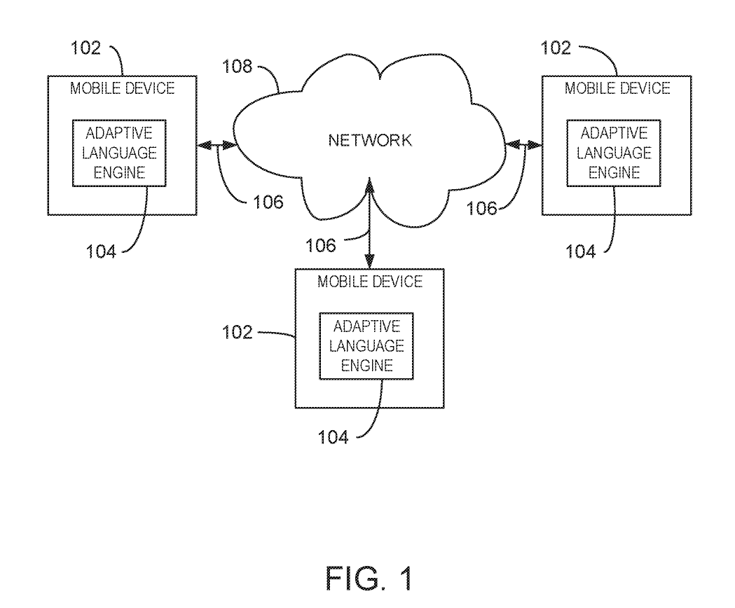

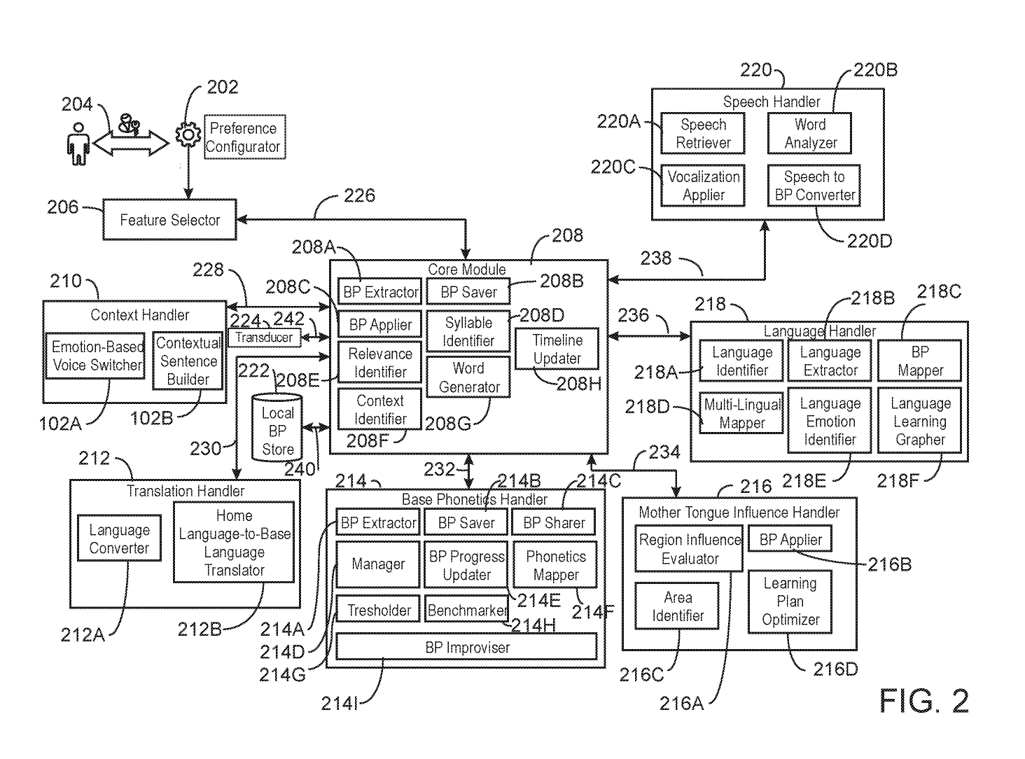

FIG. 1 is a block diagram of an example system 100 for interacting in different languages using base phonetics. The system 100 includes a number of mobile devices 102 including adaptive language engines 104. The mobile devices are communicatively coupled 106 to each other via a network 108.

As shown in FIG. 1, the mobile devices 102 may each have an adaptive language engine 104. In some examples, the adaptive language engine 104 may be an application that adapts to each user's style and language and enables the user to connect emotionally to other users in their language. For example, the adaptive language engine 104 may adaptively learn a user's language by continuously updating a set of base phonetics extracted from speech received from the user. Over time, the adaptive language engine 104 may thus learn and use the user's language and particular style of speech when translating speech from other users. For example, each user may have a set of associated base phonetics to use when translating the user's speech. Thus, each user may hear speech a native language and particular style and thus may be more emotionally connected to user's that speak an entirely different language or speak the same language in a different manner As discussed in detail below, the adaptive language engine 104 can also enable users to train themselves in a new language and keep track of their progress.

The diagram of FIG. 1 is not intended to indicate that the example system 100 is to include all of the components shown in FIG. 1. Rather, the example system 100 can include fewer or additional components not illustrated in FIG. 1 (e.g., additional mobile devices, networks, etc.). In addition, examples of the system 100 can take several different forms depending on the location of the mobile devices 102, etc. In some examples, adaptive language engines 104 may operate in parallel. In some examples, a single adaptive language engine 104 may be used on a single mobile device 102 to enable communication between the mobile device 102 and a user, or communication between two or more users.

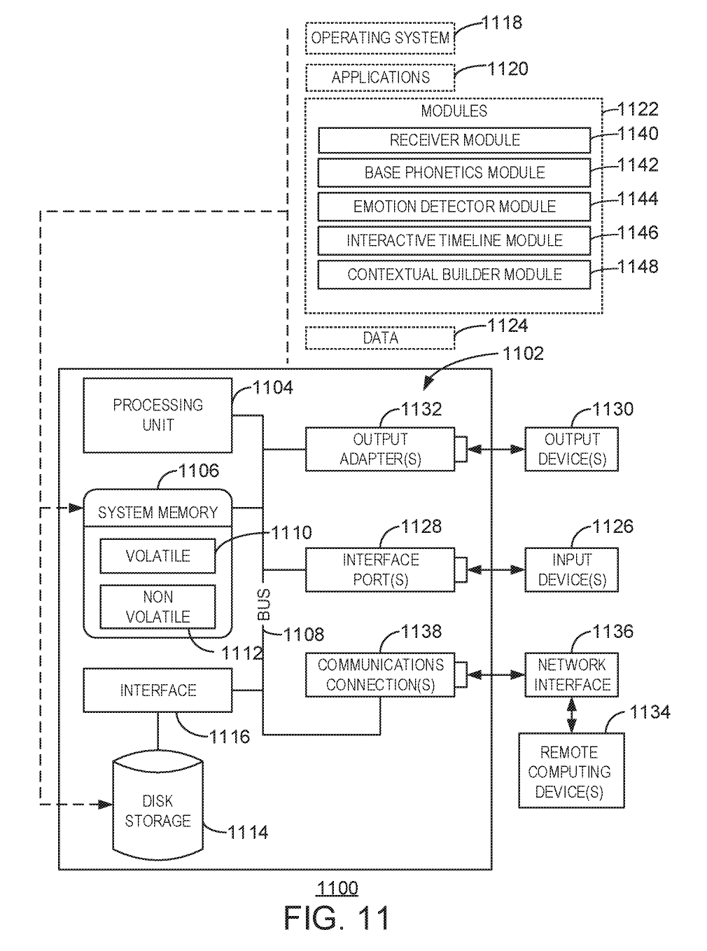

FIG. 2 is an information flow diagram of an example system for providing one or more features using base phonetics. The example system is generally referred to using the reference number 200 and can be implemented using mobile devices 102 of FIG. 1 or be implemented using the computer 1102 of FIG. 11 below.

The system 200 includes a preference configurator 202 accessible via a secure access interface 204. The system 200 includes a feature selector 206, a core module 208, a context handler 210, a translation handler 212, a base phonetics handler 214, a mother tongue influence handler 216, a language handler 218, a speech handler 220, a local base phonetics store (local BP store) 222, and a transducer 224. For example, the transducer can be a microphone or a speaker. The core module 208 includes a base phonetics extractor 208A, a base phonetics saver 208B, a base phonetics applier 208C, a syllable identifier 208D, a relevance identifier 208E, a context identifier 208F, a word generator 208G, and a timeline updater 208H. The context handler 210 includes an emotion-based voice switcher 210A and a contextual sentence builder 210B. The translation handler 212 includes a language converter 212A and home language-to-base language translator 212B. The base phonetics handler 214 include a base phonetics extractor 214A, a base phonetics saver 214B, a base phonetics sharer 214C, a base phonetics tap manager 214D, a base phonetics progress updater 214E, a phonetics mapper 214F, a base phonetics thresholder 214G, a base phonetics benchmarker 214H, and a base phonetics improviser 2141. The mother tongue influence handler 216 includes a region influence evaluator 216A, a base phonetics applier 216B, an area identifier 216C, and a learning plan optimizer 216D. The language handler 218 includes a language identifier 218A, a language extractor 218B, a base phonetic mapper 218C, a multi-lingual mapper 218D, an emotion identifier 218E, and a language learning grapher 218F. The speech handler 220 includes a speech retriever 220A, a word analyzer 220B, a vocalization applier 220C, and a speech to base phonetics converter 220D. The core module 208 can receive a selection of one or more feature selections and provide one or more features as indicated by a dual-sided arrow 226. The core module 208 is also communicatively coupled to the context handler 210, the translation handler 212, the base phonetics handler 214, the mother tongue influence handler 216, the language handler 218, the speech handler 220, the local BP store 222, and the microphone/speaker 224, as indicated by two-sided arrows 226, 228, 230, 232, 234, 236, 238, 240, and 242, respectively.

As shown in FIG. 2, the preference configurator 202 can set one or more user preferences in response to receiving a preference selection from a user via a secure access interface 204. For example, the secure access interface 204 may be an encrypted network connection or a secure device interface. In some examples, the preference configurator 202 may receive one or more preference selections, including a daily routine, a voice preference, a region, and a home language, among other possible preference selections. For example, the daily routine preference may be used to generate an individualized set of base phonetics for a new user derived from the words generated based on the daily routine of the user. The voice preference may be used to select a voice for an application to use when interacting with the user and also to choose a voice based on the mood of the user. For example, the application may be an auditory user interface application, a translation application, a social media application, a language learning application, among other types of applications using base phonetics.

The feature selector 206 may enable one or more features in response to receiving a feature selection from a user. For example, the features may include learning a new user, tap and sharing of base phonetics, multi-lingual context switching, new language learning, voice personalization, contextual expression and sentence building. In some examples, the learning a new user feature may include receiving one or more audio samples from a user to process and extract base phonetics therefrom. For example, the audio sample may be a description of a typical daily routine. In some examples, the tap and sharing of base phonetics feature may enable two or more users to share base phonetics between devices. For example, the tap and sharing feature may used for communicating across languages between two or more people. In some examples, the tap and sharing feature may also enable specially-abled to communicate with abled people or people speaking different languages to communicate with each other by sharing base phonetics. In some examples, the multi-lingual context switching feature may enable a user to interact with other users in their own native languages. For example, the extracted base phonetics for each user can be used to translate between two or more native languages. In some examples, the new language learning feature may enable a user to learn new languages in an efficient manner based on the user's base phonetics. For example, a customized learning plan can be generated for the user as described below. In some examples, the voice personalization feature may enable a user to interact with a device in the user's native language. For example, the device can extract base phonetics while interacting with a user and adapt to the user's style and language. In some examples, the contextual expression feature may enable specially-abled individuals to communicate with abled individuals. For example, the sentence builder feature may fill missing elements of sentences to enable abled individuals to better understand the sentences. These features may be performed or provided by the core module 208 and one or more of the context handler 210, the translation handler 212, the base phonetics handler 214, the mother tongue influence handler 216, the language handler 218, the speech handler 220, the local base phonetics store 222, and the microphone/speaker 224.

The core module 208 may receive a selected feature from the feature selector 206 and audio from the microphone 224. The base phonetics extractor 208A can then extract base phonetics from the received audio. For example, the base phonetics extractor 208A can retrieve a voice and its parameters and attributes, and then extract the syllables from each word spoken in the voice to extract base phonetics. The base phonetics saver 208B can save the extracted base phonetics to a storage device. For example, the storage device can be the local base phonetics store 222. The base phonetics applier 208C can apply one or more sets of base phonetics to a voice. For example, the base phonetics applier 208C can apply base phonetics to a voice to be used by a device in interactions with a user. In some examples, the base phonetics applier 208C can combine two or more base phonetics to generate a voice to use to interact with a user. The syllable identifier 208D can identify syllables in received audio. For example, the syllable identifier 208D can be used to extract base phonetics instead of relying on vocal parameters. The relevance identifier 208E can identify the relevance of one or more base phonetics to a received audio. In some examples, the relevance identifier 208E can be used for multiple purposes such as identifying the relevance of a base language while the user wants to learn a corresponding language. In some examples, the relevance identifier 208E can be used for specially-abled people who are not able to complete their sentences. The context identifier 208F can identify a context within a received audio based on a set of base phonetics. For example, in the case of multi-lingual conversations, the contextual switcher feature can use the contextual identifier to identify the different contexts available to the system at any point in time. In some examples, the contextual identify may identify multiple people speaking different languages, or multiple people speaking same language, but in different situations. The word generator 208G can generate words based on base phonetics to produce a voice that sounds like the user's voice. The timeline updater 208H can update a timeline based on information received from the language handler 218. For example, the timeline may show progress in learning a language and scheduled lessons based on the information received from the language handler 218.

In some examples, the context handler 210 may be used to enable emotion-based voice switching. The emotion-based voice switcher 210A may receive a detected context from the context identifier 208F of the core module 208 and switch a voice used by a device based on the detected context. For example, the emotion-based voice switcher 210A can detect a mood of the user and switch a voice to be used by the device in interacting with the user to a voice configured for the detected mood. The voice may be, for example, the voice of a relative or a friend of the user. In some examples, the voice of the friend or relative may be retrieved from a mobile device of the friend or relative. In some examples, the voice of a friend or relative may be retrieved from a storage device or recorded. Thus, the context handler 210 may enable the device to use different voices based on the detected mood of a user. In some examples, the context handler 210 may be used to build sentences contextually. For example, the contextual sentence builder 210B may receive an identified specially-abled context from the context identifier 208F. The contextual sentence builder 210B may also receive one or more incomplete sentences from the core module 208. The contextual sentence builder 210B may then detect one or more missing words from the incomplete sentences based on the set of base phonetics of the specially-abled user and fill in the missing words. The contextual sentence builder 210B may then send the completed sentences to the core module 208 to voice the completed sentences via the speaker 224 to another user or send the completed sentences via the secure access interface 204 to another device.

In some examples, the translation handler 212 can translate an input speech into a base language based on the set of base phonetics. For example, the base language may be the language and style of speech corresponding to the audio from which the base phonetics were extracted. In some examples, the language converter 212A can convert an input speech into a home language. For example, the home language may be English, Spanish, French, Hindi, etc. In some examples, the home language-to-base language translator 212B can translate the input speech from the home language into a base language based on the set of base phonetics associated with the base language. For example, the home language-to-base language translator 212B can translate the input speech from Hindi to a dialect and personal style of speech corresponding to the set of base phonetics.

In some examples, the base phonetics handler 214 can receive audio input and extract base phonetics from the audio input. For example, the audio input may be a described daily routine or other prompted input. In some examples, the audio input can be daily speech used in interacting with a device. In some examples, the base phonetics extractor 214A can extract base phonetics from the audio input. For example, the base phonetics extractor 214A may be a shared component in the core module 208 and thus may have the same functionality as base phonetics extractor 208A. The base phonetics saver 214B can then save the extracted base phonetics to a storage device. For example, the base phonetics saver 214B can send the base phonetics to the core module 208 to store the extracted base phonetics in the local base phonetics store 222. In some examples, the base phonetics saver 214B may also be a shared component of the core module 208. In some examples, the base phonetics sharer 214C can provide base phonetics sharing between devices. For example, the base phonetics sharer 214C can send and receive base phonetics via the secure access interface 204. In some examples, the base phonetics tap manager 214D can enable easier sharing of base phonetics. For example, two devices may be tapped in order to share base phonetics between the two devices. In some examples, near-field communication (NFC) techniques may be used to enable transfer of the base phonetics between the two devices. In some examples, the base phonetics progress updater 214E can update a progress metric corresponding to base phonetics extraction. For example, a threshold number of base phonetics may be extracted before the base phonetics extractor 214A can stop extracting base phonetics 214A for more efficient device performance. In some examples, the progress towards the threshold number of base phonetics can be displayed visually. Thus, users may provide additional audio samples for base phonetics extraction to hasten the progress towards the threshold number of base phonetics. In some examples, the phonetics mapper 214F can map extracted base phonetics to user learnings. In some examples, the base phonetics thresholder 214G can threshold the extracted base phonetics. For example, the base phonetics thresholder 214G can set a base phonetics threshold for each user so that the system can adjust its learnings accordingly and derive a better learning plan. In some examples, the base phonetics benchmarker 214H can benchmark the base phonetics. For example, the base phonetics benchmarker 214H can benchmark base phonetics using existing benchmark values. In some examples, the base phonetics improviser 2141 can improvise one or more base phonetics. For example, the base phonetics improviser 2141 can improvise one or more base phonetics with respect to the style of speaking of a user.

In some examples, the mother tongue influence handler 216 can help provide improved language learning by identifying areas on which to focus study. For example, the region influence evaluator 216A can evaluate the influence that a particular region may have on a user's speech. In some examples, the base phonetics applier 216B can apply base phonetics to the voice of a user. For example, the base phonetics may provide uniqueness and the style to a user's voice, which is unique to them. In some examples, the base phonetics may be applied to an existing user's voice or to generate a user's voice using base phonetics applied along with the other parameters and attributes of the user's voice. The area identifier 216C can then identify areas to concentrate on for study using home language characteristics. For example, the home language characteristics can include the way the home language is spoken, including the style, the modulation, the syllable impression, etc. The learning plan optimizer 216D can then optimize a learning plan based on the identified areas. For example, areas more likely to give a user more difficult may be taught first, or may be spread out to level or soften the learning curve for learning a given language.

In some examples, the language handler 218 can provide support for improved language learning and multi-lingual context switching to switch between multiple languages when multiple people are interacting. For example, the language identifier 218A can identify different languages. The different languages may be spoken by two or more users. The language extractor 218B can extract different languages from received audio input. For example, language extractor 218B can extract different languages during multi-lingual interactions when a voice input carries multiple languages. The base phonetic mapper 218C can map a language to a set of base phonetics. For example, the base phonetic mapper 218C may apply base phonetics on the user's voice along each language's characteristics as derived. In some examples, the mapping can be used to translate speech corresponding to the base phonetics into any of the multiple languages in real-time. The multi-lingual mapper 218D can map concepts and phrases between two or more languages. For example, a variety of greetings, farewells, or activity descriptions can be mapped between different languages. The emotion identifier 218E can identify an emotion in a language. For example, different languages may have different expressions of emotion. The emotion identifier 218E may thus be used to identify an emotion in one language and express the same emotion in a different language during translation of speech. The language learning grapher 218F can generate a language learning graph. For example, the language learning graph can include a user's progress in learning one or more languages.

In some examples, the speech handler 220 can analyze received speech. For example, the speech retriever 220A can retrieve speech from the core module 208. The word analyzer 220B can then analyze spoken words in the retrieved speech. For example, word analyzer 220B can be used for emotional identification, splitting each word, syllable splitting and language identification. The vocalization applier 220C can apply vocalization of configured voices associated with family or friends. For example, the user may have configured one or more voices to be used by the device when interacting with the user. The speech to base phonetics converter 220D can convert received speech into base phonetics associated with a user. For example, the speech to base phonetics converter 220D can convert speech into base phonetics and then save the base phonetics. The base phonetics can then be applied to the user's voice.

The core module 208 and various handlers 210, 212, 214, 216, 218, 220 may thus be used to provide a variety of services based on the received feature selection 206. For example, the core module 208 can perform routine-based linguistic modeling. In this example, the core module 208 can receive a daily routine from the user and generate words for user articulation. For example, the core module 208 may send the received daily routine to the base phonetics handler 214 and retrieve the user's base phonetics from the base phonetics handler 214. The base phonetics can contain various voice attributes along with his articulatory phonetics. In some examples, the base phonetics can then be used for interactive responses between the device and the user in the user's own style and language via the microphone/speaker 224.

In some examples, the core module 208 may provide emotion-based voice switching. For example, the core module 208 can send received audio to the language handler 218. The language handler 218 can then extract the user emotions from the user's voice attributes to aid in switching a voice based on the user's choice. The core module 208 may then provide emotional-state-based switching to help in aligning a device to a user's state of mind. For example, different voices may be used in interacting with the user based on the user's emotional state.

In some examples, the core module 208 may provide base phonetics benchmarking and thresholding. For example, during user action and language learning, the core module 208 may send audio received from a user to a base phonetics handler 214. The core module 208 may then receive extracted base phonetic metrics from the base phonetics handler 214. For example, the base phonetics handler 214 can benchmark the base phonetic metrics and derive thresholds for each voice parameter for a given word. The benchmarked and threshold base phonetics improve a device's linguistic capability to interact with the user and help the user learn new languages in their own way. In some example, the thresholds can be used to determine how long the core module 208 can tweak the base phonetics. For example, the base phonetics may be modified until the voice of the user is accurately learned. In some examples, the core module 208 can also provide the user with controls to fix the voice if the user feels the voice does not sound accurate. For example, the user may be able to alter one or more base phonetics manually. For example, after such an alteration, the core module 208 may not update the voice, and rather use the same voice characteristics as last updated and indicated to be final by the user. In some examples, the core module 508 may also indicate a match of the simulated voice to the user's voice as a percentage.

In some examples, the core module 208 can provide vocalization of customizable voices. For example, the voices can be voices of relatives or friends. In some examples, the core module 208 allows a user to configure a few voices of their choice. For example, the voices can be that of friends or family members that the user misses. The use of customizable voices can enable the user to listen to such voices on certain important occasions for the user. The customizable voices feature can thus provide an emotional connect to the user in the absence of the one or more people associated with the voice.

In some examples, the core module 208 may provide voice personalization. For example, the user can be allowed to choose and provide a voice to be used by a device during interaction with the user. For example, the voice can be a default voice or the user's voice. This enables the system to interact with the user in the configured voice. Such an interaction can make the user feel more connected with the device because the expression of the device may be more understandable by the user.

In some examples, the core module 208 can provide services for the specially-abled. For example, the core module 208 may provide base phonetics-based icebreakers for communication between the specially-abled and abled. In this example, the core module 208 can enable a user to tap and share their base phonetics with each other. After the base phonetics are shared, the core module 208 can enable a device to act as a mediator to provide interactive linguistic flexibility between two users. For example, the mediation may help in crossing language boundaries and provide a scope for seamless interaction between the specially-abled and abled.

In some examples, the core module 208 can analyze a mother tongue influence and other language influences for purposes of language learning. In this example, the core module 208 collects region-based culture information along with the home culture. This information can be used in identifying the region based language influence when a user learns any new language. The information can also help to optimize the learning curve for a user by creating a user-specific learning plan and an updated timeline for learning a language. In some examples, the core module 208 can generate a learning plan for the user based on the base phonetics and check the home language to see if the language to be learned and the home language are both part of the same language hierarchy. In some examples, the core module 208 can create a learning plan based on region influence and then use the learning plan to convert the spoken words into English and then back to the user's language.

In some examples, the core module 208 can provide contextual language switching. In this example, when multiple users are interacting with the device, the core module 508 can identify each individual's home language by retrieving their home language or using their base phonetics. The home language or base phonetics can then be used to respond to individuals in their corresponding style and home language. Such contextual language switching helps provide a contextual interaction and improved communication between the users.

In some examples, the core module can provide contextual sentence filling. For example, the core module 208 may help in filling gaps in the user's sentences when they interact with the device. For example, the core module 208 can send received audio to a contextual sentence builder of the context handler 210 that can set a context and fill in missing words. The contextual sentence builder can help users, in particular the specially-abled, to express themselves when speaking and writing mails, in addition to helping users understand speech and helping users to read.

The diagram of FIG. 2 is not intended to indicate that the example system 200 is to include all of the components shown in FIG. 2. Rather, the example system 200 can include fewer or additional components not illustrated in FIG. 2 (e.g., additional mobile devices, networks, etc.).

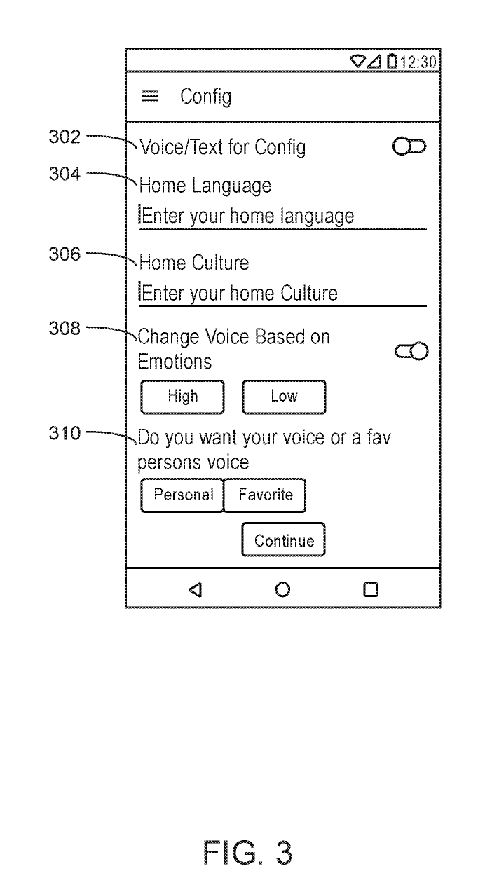

FIG. 3 is an example configuration display for a linguistic modeling application. The example configuration display is generally referred to using the reference number 300 and can be presented on the mobile devices 102 of FIG. 1 or be implemented using the computer 1102 of FIG. 11 below.

As shown in FIG. 3, the configuration display 300 includes a voice/text option 302 for configuration, a home language 304, a home culture 306, an emotion-based voice option 308, and a favorite voice option 310.

In the example of FIG. 3, a voice/text option 302 can be set for configuration. For example, the system may receive either voice recordings or text from the user to perform an initial extraction of base phonetics for the user. The linguistic modeling application can then extract additional base phonetics during normal operation later on. Thus, the linguistic modeling application can begin with basic greetings and responses, and then progress to more sophisticated interactions as it collects additional base phonetics from the user. For example, the application may analyze different voice parameters, such as pitch, modulation, tone, inflection, timbre, frequency, pitch, pressure, etc. For example, the system may detect points of articulation based on the voice parameters, and detect whether the voice is nasal or not.

In some examples, the user may set a home language 304. For example, the home language may be a language such as English, Spanish, Hindi, Mandarin, or any other language.

In some examples, the user may set a home culture. For example, if the user selected Spanish, then the user may further input a specific region. For example, the region may be the United States, Mexico, or Argentina. In some examples, the home culture may be a specific region within a country, such as Texas or California in the United States. In some examples, region-based culture information can be used to identify regional languages when a user wants to learn a new language.

In some examples, the user may enable an emotional state based voice option 308. For example, the linguistic modeling application can then detect emotional states of the user and change the voice it uses to interact with the user accordingly. In some examples, the user may select different voices 310 to use for different emotional states. For example, the linguistic modeling application may use a close relative when the user is detected as feeling sad or depressed and a friend when the user is feeling happy or excited. In some examples, the linguistic modeling application may be configured to mimic the voice of the user to provide a personal experience. In some examples, the user may select a favorite voice option 310 between a favorite voice and the user's own personal voice.

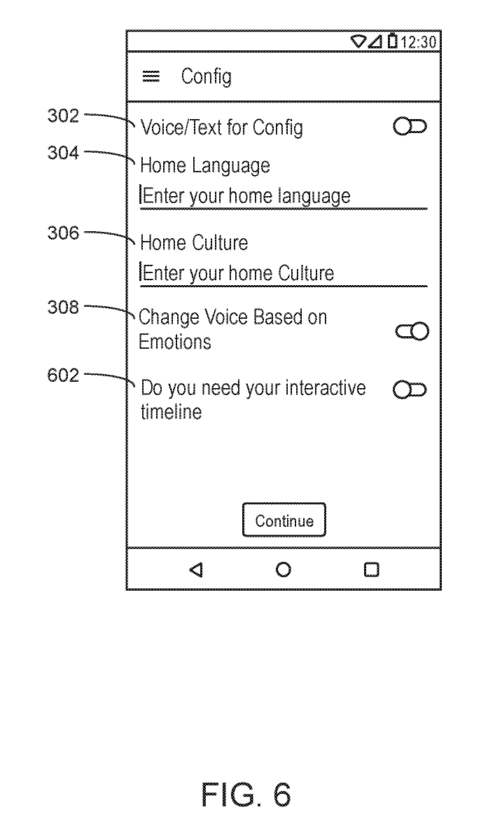

The diagram of FIG. 3 is not intended to indicate that the example configuration display 300 is to include all of the components shown in FIG. 3. Rather, the example configuration display 300 can include fewer or additional components not illustrated in FIG. 3 (e.g., additional options, features, etc.). For example, the configuration display 300 may include an additional interactive timeline feature as described in FIG. 6 below.

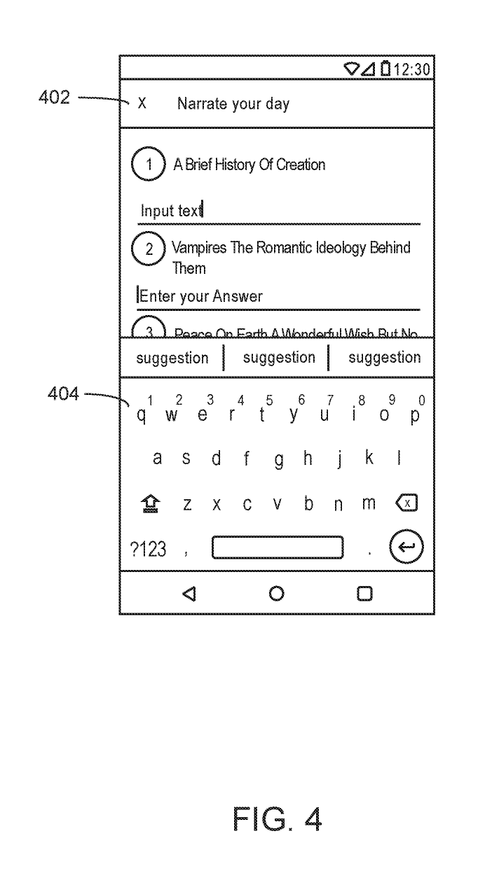

FIG. 4 is an example daily routine input display of a linguistic modeling application. The daily routine input display is generally referred to by the reference number 400 and can be presented on the mobile devices 102 of FIG. 1 using the computer 1102 of FIG. 11 below.

The daily routine input display 400 includes a prompt 402 and a keyboard 404. As shown in FIG. 4, a user may narrate a typical day in order to provide the linguistic modeling application a voice-recording sample from which to extract base phonetics. For example, the keyboard may be used in the initial configuration. In some examples, the text may be auto generated based on the daily routine and other preferences of the user. The user may then be prompted to read the text so that the system can learn the user's voice. Prompting for a typical user daily routine can increase the variety and usefulness of base phonetics received, as the user will describe actions and events that are more likely to be repeated each day. In addition, a daily routine may provide a range of emotions that the system can analyze to calibrate different emotional states for the user. For example, the application may associate particular base phonetics and voice attributes with particular emotional states. In some examples, emotional states may include general low versus normal emotional states, or emotional states based on specific emotions. For example, voice attributes can include pitch, timbre, pressure, etc.

In some examples, the linguistic modeling application may prompt the user to provide additional information. For example, the application may prompt the user to provide a home language, a home culture, in addition to other information.

The diagram of FIG. 4 is not intended to indicate that the example daily routine input display 400 is to include all of the components shown in FIG. 4. Rather, the example daily routine input display 400 can include fewer or additional components not illustrated in FIG. 4 (e.g., additional prompts, input devices, etc.). For example, the linguistic modeling application may also include a configuration of single-tap or double-tap for those with special needs. For example, yes could be a single-tap and no could be a double-tap.

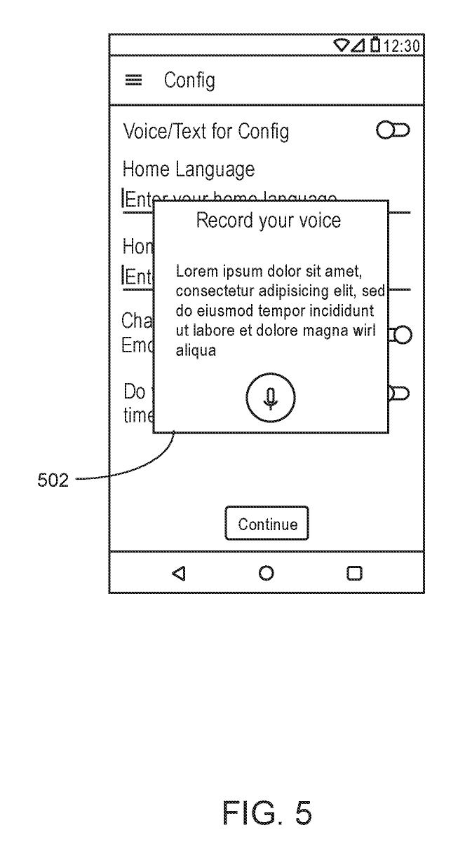

FIG. 5 is an example voice recording display of a linguistic modeling application. The daily routine input display is generally referred to by the reference number 500 and can be presented on the mobile devices 102 of FIG. 1 using the computer 1102 of FIG. 11 below.

The voice recording display 500 includes a prompt 502 directing the user to record a voice recording. For example, the user may record a voice recording corresponding to text displayed in the prompt 502. In some examples, the prompt 502 may ask the user to record a voice recording with more general instructions. For example, the prompt 502 may ask the user to record a description of a typical daily routine.

As shown in FIG. 5, the user may start the recording by pressing the button of a microphone. The computing device may then begin recording the user. The user may then press the microphone button again to stop recording. In some examples, the user may alternatively hold down the recording button to record a voice recording. In some examples, the user may enable voice recording using voice commands or any other suitable method.

The diagram of FIG. 5 is not intended to indicate that the example voice recording display 500 is to include all of the components shown in FIG. 5. Rather, the example voice recording display 500 can include fewer or additional components not illustrated in FIG. 5 (e.g., additional displays, input devices, etc.).

FIG. 6 is another example configuration display for a linguistic modeling application. The configuration display is generally referred to by the reference number 600 and can be presented on the mobile devices 102 of FIG. 1 using the computer 1102 of FIG. 11 below.

The configuration display 600 includes similarly numbered features described in FIG. 3 above. The configuration display 600 also includes an interactive timeline option 602. For example, the user may enable the interactive timeline option 602 when learning a new language. The interactive timeline option 602 may enable the computing device to provide the user with a customized timeline for learning one or more new languages. For example, the user may be able to track language-learning progress using the interactive timeline.

The diagram of FIG. 6 is not intended to indicate that the example configuration display 600 is to include all of the components shown in FIG. 6. Rather, the example configuration display 600 can include fewer or additional components not illustrated in FIG. 6 (e.g., additional options, features, etc.).

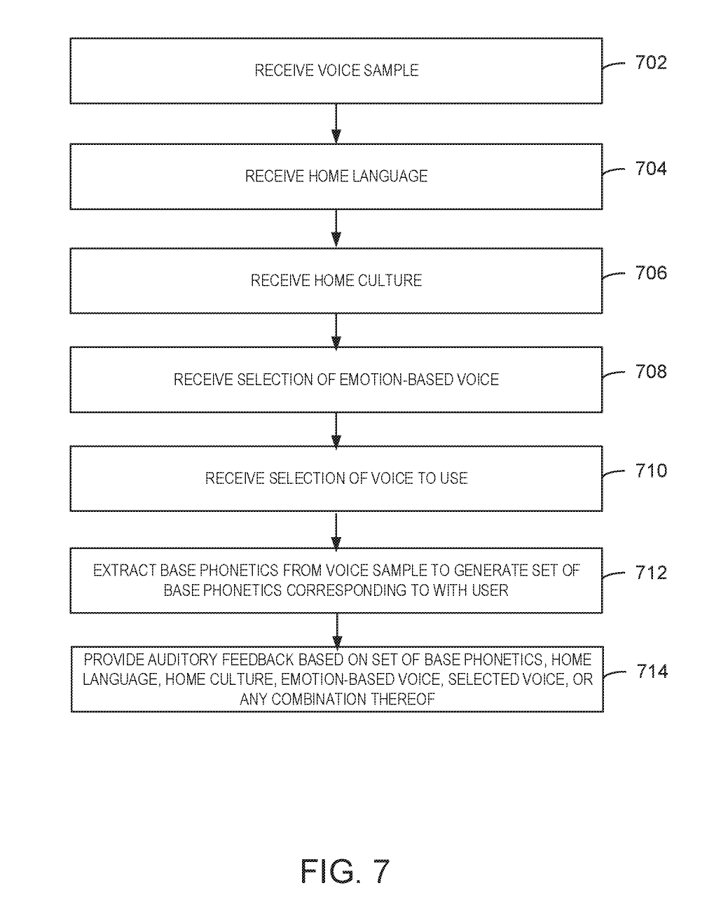

FIG. 7 is a process flow diagram of an example method for configuring a linguistic modeling program. One or more components of hardware or software of the operating environment 1100, may be configured to perform the method 700. For example, the method 700 may be performed using the processing unit 1104. In some examples, various aspects of the method may be performed in a cloud computing system. The method 700 may begin at block 702.

At block 702, a processor receives a voice sample. For example, the voice sample may be a recorded response to a prompt. In some examples, the recorded response may describe a typical daily routine of the user.

At block 704, the processor receives a home language. For example, the home language may be a general language such as English, Spanish, or Hindi.

At block 706, the processor receives a home culture. For example, the home culture may be a region or particular dialect of a language in the region.

At block 708, the processor receives a selection of emotion-based voice. For example, if an emotion-based voice feature is selected, then the system may respond with different voices based upon a detected emotional state of the user. If the emotion based-voice feature is not selected, then the system may disregard the detected emotional state of the user when responding.

At block 710, the processor receives a selection of a voice to use. For example, a user may select a favorite voice to use, such as the voice of a family member, a friend, or any other suitable voice. In some examples, the user may select to use their own voice in receiving responses from the system. For example, the system may adaptively learn the user's voice over time by extracting base phonetics associated with the user's voice.

At block 712, the processor extracts base phonetics from the voice sample to generate a set of base phonetics corresponding to the user. For example, the base phonetics may include intonation, among other voice attributes. In some examples, the system may receive a daily routine from the user and provide words for user articulation. In some examples, the processor may detect one or more base phonetics in the voice sample and store the base phonetics in a linguistic model.

At block 714, the processor provides auditory feedback based on the set of base phonetics, home language, home culture, emotion-based voice, selected voice, or any combination thereof. For example, the auditory feedback may be computer-generated speech in a voice that is based on the set of base phonetics. In some examples, the auditory feedback may be provided in the user's language, dialect, and style of speech. Thus, the processor may interact with the user in the user's particular style of speech or dialect and may thereby improve user understandability of the device from the user's perspective. In some examples, the processor may receive a voiced query from the user and return auditory feedback in the user's style with an answer to the query in response.

This process flow diagram is not intended to indicate that the blocks of the method 700 are to be executed in any particular order, or that all of the blocks are to be included in every case. Further, any number of additional blocks not shown may be included within the method 700, depending on the details of the specific implementation.

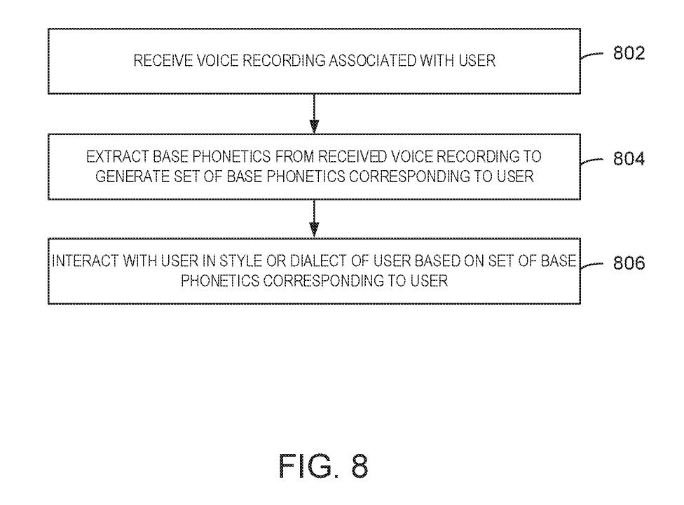

FIG. 8 is a process flow diagram of an example method for interaction between a device and a user using base phonetics. One or more components of hardware or software of the operating environment 1100, may be configured to perform the method 800. For example, the method 800 may be performed using the processing unit 1104. In some examples, various aspects of the method may be performed in a cloud computing system. The method 800 may begin at block 802.

At block 802, a processor receives a voice recording associated with a user. For example, the voice recording may be a description of a daily routine. In some examples, the voice recording may be a prompted text provided to the user to read. In some examples, the voice recording may be a user response to a question or greeting played by the processor.

At block 804, the processor extracts base phonetics from the received voice recording to generate a set of base phonetics corresponding to the user. For example, the base phonetics may include various voice attributes along with articulatory phonetics. In some examples, the voice attributes can include pitch, timbre, pressure, tone, modulation, etc.

At block 806, the processor interacts with the user in a style or dialect of the user based on the set of base phonetics corresponding to the user. For example, the processor may respond to the user using a voice and choice of language or responses that are based on the set of base phonetics. In some examples, the processor may receive additional voice recordings associated with the user and update the base phonetics. For example, the additional voice recordings may be received while interacting with the user in the user's style or dialect. In some examples, in addition to extracting base phonetics while interacting with the user, the processor may also update a user style and dialect.

This process flow diagram is not intended to indicate that the blocks of the method 800 are to be executed in any particular order, or that all of the blocks are to be included in every case. Further, any number of additional blocks not shown may be included within the method 800, depending on the details of the specific implementation.

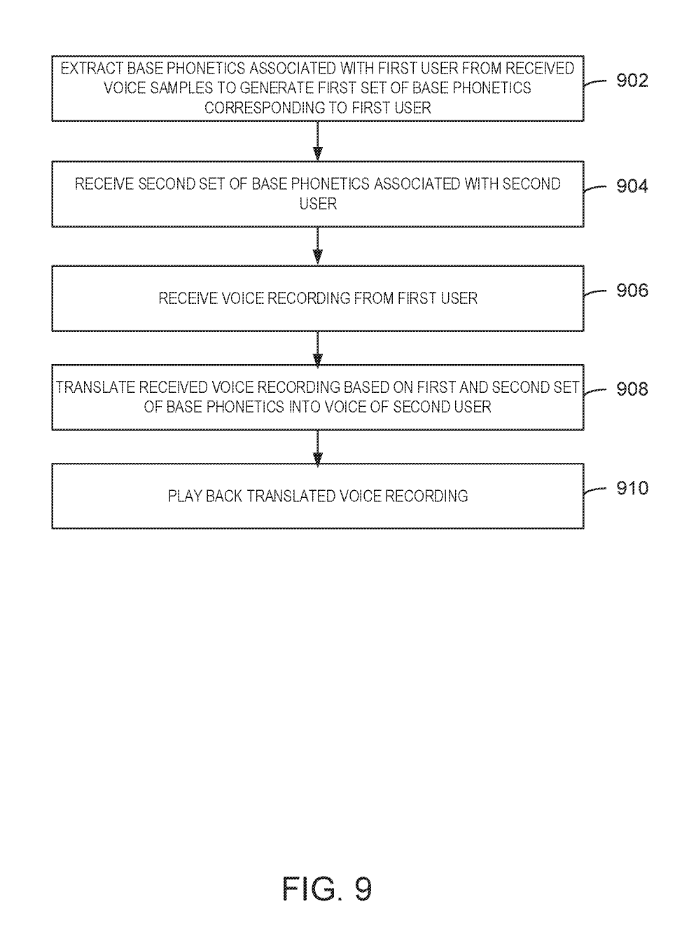

FIG. 9 is a process flow diagram of an example method for translating language between users using base phonetics. One or more components of hardware or software of the operating environment 1100, may be configured to perform the method 900. For example, the method 900 may be performed using the processing unit 1104. In some examples, various aspects of the method may be performed in a cloud computing system. The method 900 may begin at block 902.

At block 902, a processor extracts base phonetics associated with a first user from received voice samples to generate a set of base phonetics corresponding to the user. For example, the base phonetics may include various voice attributes along with articulatory phonetics. In some examples, the voice attributes can include pitch, timbre, pressure, tone, modulation, etc. For example, the processor may receive the base phonetics from the first user via a storage or another device. In some examples, the processor may have received recordings from the first user and extracted base phonetics for the user.

At block 904, the processor receives a second set of base phonetics associated with a second user. For example, the second set of base phonetics may be received via a network or from another device. The second set of base phonetics may have been extracted from one or more voice recordings of the second user.

At block 906, the processor receives a voice recording from the first user. For example, the voice recording may be a message to be sent to the second user. For example, the recording may be an idea expressed in the language or style of the first user to be conveyed to the second user in the language or style of the second user. In some examples, the users may speak different languages. In some examples, the users may speak different dialects. In some examples, the first user may be a specially-abled user and the second user may not be a specially-abled user.

At block 908, the processor translates the received voice recording based on the first and second set of base phonetics into a voice of the second user. For example, the processor can convert the recording into a base language from the style of the first user. In some examples, the core module 208 can generate a learning plan for the user based on the base phonetics and check the home language to see if the language to be translated and the home language are both part of the same language hierarchy. In some examples, the core module 208 can create a learning plan based on region influence and then use the learning plan to convert the spoken words of the language to be translated into English and then back to the user's language. In some examples, the processor can then convert the base language of the first user into the base language of the second user. The processor can then convert the recording from the base language of the second user into the style of the second user using the set of base phonetics associated with the second user. In some examples, a common base language, such as English, can be used to translate between base phonetics. For example, one set of base phonetics may be used to translate the recording into English, and the second set of base phonetics may be used to translate the recording from English into a second language. For example, the processor may translate the received voice recording into the language and style of the second user, so that the second user may better understand the message from the first user.

At block 910, the processor plays back the translated voice recording. For example, the second user may listen to the translated voice recording. In some examples, the processor may receive a voice recording from the second user and translate the voice recording into the language and style of the first user to enable the first user to understand the second user. Thus, the first and the second user may communicate via the processor in their native languages and styles. In some examples, the device may thus serve as a form of icebreaker between individuals having different native languages. For example, the translated recording may be voiced in the language and style of the second user. Thus, the second user may be able to understand the idea that the first user was attempting to convey in the recording

This process flow diagram is not intended to indicate that the blocks of the method 900 are to be executed in any particular order, or that all of the blocks are to be included in every case. Further, any number of additional blocks not shown may be included within the method 900, depending on the details of the specific implementation. For example, the processor may also enable interaction between specially-abled and abled individuals as described below. In some examples, the processor may fill in gaps in speech to translate speech from a specially enabled individual to enable improved understanding of the specially enabled individual by another individual.

This process flow diagram is not intended to indicate that the blocks of the method 900 are to be executed in any particular order, or that all of the blocks are to be included in every case. Further, any number of additional blocks not shown may be included within the method 900, depending on the details of the specific implementation.

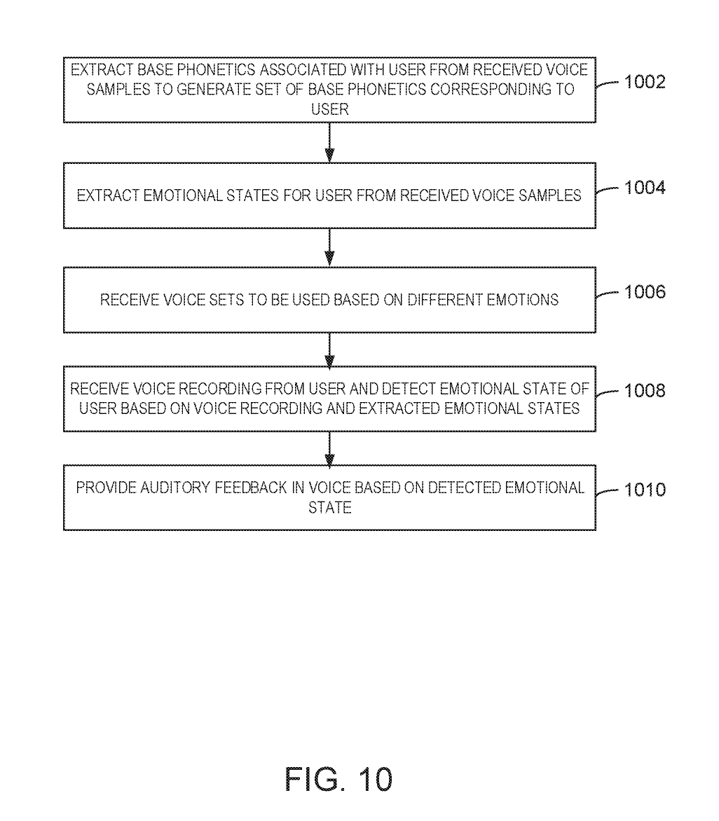

FIG. 10 is a process flow diagram of an example method for configuring a linguistic modeling program. One or more components of hardware or software of the operating environment 1100, may be configured to perform the method 1000. For example, the method 1000 may be performed using the processing unit 1104. In some examples, various aspects of the method may be performed in a cloud computing system. The method 1000 may begin at block 1002.

At block 1002, a processor extracts base phonetics associated with a user from received voice samples to generate a set of base phonetics corresponding to a user. For example, the user may provide an initial voice sample describing a typical daily routine. The processor may then extract base phonetics, including voice attributes and voice parameters, from the voice sample. The extracted set of base phonetics may then be stored in a base phonetics library for the user. In some examples, the processor may also extract base phonetics from subsequent interactions with the user. The processor may then update the set of base phonetics in the library after each user interaction with the user.

At block 1004, the processor extracts emotional states for first user from received voice samples. For example, the processor may associate a combination of voice parameters with specific emotional states. In some examples, the processor may then store the combinations for use in detecting emotional states. In some examples, the processor may receive detected emotional states from a language emotion identifier that can retrieve emotional states from speech.

At block 1006, the processor receives voice sets to be used based on different emotions. For example, a user may select from one or more voice sets to be used for particular detected emotional states. For example, a user may listen to a friend's voice when upset. In some examples, the user may select a relative's voice to listen to when the user is sad.

At block 1008, the processor receives a voice recording from user and detects an emotional state of the user based on the voice recording and the extracted emotional states. For example, the processor may receive the voice recording during a daily interaction with the user.

At block 1010, the processor provides auditory feedback in voice based on detected emotional state. For example, the processor may detect an emotional state when interacting with the user. The processor may then switch voices to the voice set that is associated with the detected emotional state. For example, the processor may switch to a relative's voice in response to detecting that the user is sad or depressed.

This process flow diagram is not intended to indicate that the blocks of the method 1000 are to be executed in any particular order, or that all of the blocks are to be included in every case. Further, any number of additional blocks not shown may be included within the method 1000, depending on the details of the specific implementation.

FIG. 11 is intended to provide a brief, general description of an example operating environment in which the various techniques described herein may be implemented. For example, a method and system for presenting educational activities can be implemented in such an operating environment. While the claimed subject matter has been described above in the general context of computer-executable instructions of a computer program that runs on a local computer or remote computer, the claimed subject matter also may be implemented in combination with other program modules. Generally, program modules include routines, programs, components, data structures, or the like that perform particular tasks or implement particular abstract data types. The example operating environment 1100 includes a computer 1102. The computer 1102 includes a processing unit 1104, a system memory 1106, and a system bus 1108.

The system bus 1108 couples system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure, including the memory bus or memory controller, a peripheral bus or external bus, and a local bus using any variety of available bus architectures known to those of ordinary skill in the art. The system memory 1106 includes computer-readable storage media that includes volatile memory 1110 and nonvolatile memory 1112.

The basic input/output system (BIOS), containing the basic routines to transfer information between elements within the computer 1102, such as during start-up, is stored in nonvolatile memory 1112. By way of illustration, and not limitation, nonvolatile memory 1112 can include read-only memory (ROM), programmable ROM (PROM), electrically programmable ROM (EPROM), electrically erasable programmable ROM (EEPROM), or flash memory.

Volatile memory 1110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 1102 also includes other computer-readable media, such as removable/non-removable, volatile/non-volatile computer storage media. FIG. 11 shows, for example a disk storage 1114. Disk storage 1114 includes, but is not limited to, devices like a magnetic disk drive, floppy disk drive, tape drive, Jaz drive, Zip drive, LS-210 drive, flash memory card, memory stick, flash drive, and thumb drive.

In addition, disk storage 1114 can include storage media separately or in combination with other storage media including, but not limited to, an optical disk drive such as a compact disk, ROM device (CD-ROM), CD recordable drive (CD-R Drive), CD rewritable drive (CD-RW Drive), a digital versatile disk (DVD) drive. To facilitate connection of the disk storage devices 1114 to the system bus 1108, a removable or non-removable interface is typically used such as interface 1116.

It is to be appreciated that FIG. 11 describes software that acts as an intermediary between users and the basic computer resources described in the suitable operating environment 1100. Such software includes an operating system 1118. The operating system 1118, which can be stored on disk storage 1114, acts to control and allocate resources of the computer 1102.

System applications 1120 take advantage of the management of resources by operating system 1118 through program modules 1122 and program data 1124 stored either in system memory 1106 or on disk storage 1114. In some examples, the program data 1124 may include base phonetics for one or more users. For example, the base phonetics may be used to interact with an associated user or enable the user to interact with other users that speak different languages or dialects.)

A user enters commands or information into the computer 1102 through input devices 1126. Input devices 1126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. The input devices 1126 connect to the processing unit 1104 through the system bus 1108 via interface ports 1128. Interface ports 1128 include, for example, a serial port, a parallel port, a game port, and a universal serial bus (USB).

Output devices 1130 use some of the same type of ports as input devices 1126. Thus, for example, a USB port may be used to provide input to the computer 1102, and to output information from computer 1102 to an output device 1130.

Output adapter 1132 is provided to illustrate that there are some output devices 1130 like monitors, speakers, and printers, among other output devices 1130, which are accessible via adapters. The output adapters 1132 include, by way of illustration and not limitation, video and sound cards that provide a means of connection between the output device 1130 and the system bus 1108. It can be noted that other devices and systems of devices can provide both input and output capabilities such as remote computers 1134.

The computer 1102 can be a server hosting various software applications in a networked environment using logical connections to one or more remote computers, such as remote computers 1134. The remote computers 1134 may be client systems configured with web browsers, PC applications, mobile phone applications, and the like.

The remote computers 1134 can be a personal computer, a server, a router, a network PC, a workstation, a microprocessor based appliance, a mobile phone, a peer device or other common network node and the like, and typically includes many or all of the elements described relative to the computer 1102. Remote computers 1134 can be logically connected to the computer 1102 through a network interface 1136 and then connected via a communication connection 1138, which may be wireless.

Network interface 1136 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 1138 refers to the hardware/software employed to connect the network interface 1136 to the bus 1108. While communication connection 1138 is shown for illustrative clarity inside computer 1102, it can also be external to the computer 1102. The hardware/software for connection to the network interface 1136 may include, for exemplary purposes, internal and external technologies such as, mobile phone switches, modems including regular telephone grade modems, cable modems and DSL modems, ISDN adapters, and Ethernet cards.

An example processing unit 1104 for the server may be a computing cluster. The disk storage 1114 may include an enterprise data storage system, for example, holding thousands of impressions.

The user may store the code samples to disk storage 1114. The disk storage 1114 can include a number of modules 1122 configured to implement the presentation of educational activities, including a receiver module 1140, a base phonetics module 1142, an emotion detector module 1144, an interactive timeline module 1146, and a contextual builder module 1148. The receiver module 1140, base phonetics module 1142, emotion detector module 1144, interactive timeline module 1146, and contextual builder module 1148 refer to structural elements that perform associated functions. In some embodiments, the functionalities of the receiver module 1140, base phonetics module 1142, emotion detector module 1144, interactive timeline module 1146, and the contextual builder module 1148 can be implemented with logic, wherein the logic, as referred to herein, can include any suitable hardware (e.g., a processor, among others), software (e.g., an application, among others), firmware, or any combination of hardware, software, and firmware. For example, the receiver module 1140 can be configured to receive text or voice recordings from a user. The receiver module 1140 may also be configured to receive one or more configuration options as described above with respect to FIG. 3. For example, the receiver module may receive a home language, a home culture, emotional state based voice control, or a favorite voice to use, among other options.

Further, the disk storage 1114 can include a base phonetics module 1142 configured to extract base phonetics from the received voice recordings to generate a set of base phonetics for a user. For example, the voice recordings may include words generated on a daily basis from a daily routine of the user. In some examples, the extracted base phonetics may include voice parameters and voice attributes associated with the user. In some examples, the base phonetics module 1142 can be configured to extract base phonetics during subsequent interactions with the user. For example, the base phonetics module 1142 may extract base phonetics at a regular interval, such as once a day, and update the set of base phonetics in a base phonetics library for the user. In some examples, the base phonetics library may also contain one or more sets of base phonetics associated with one or more individuals. For example, the individuals may be relatives or friends of the user. The disk storage 1114 can include an emotion detector module 1144 to detect a user emotion based on the set of base phonetics and interact with the user in a preconfigured voice based on the detected user emotion. For example, the emotion detector module 1144 can detect a user emotion that corresponds to happiness and interact with the user in a voice configured to be used during happy moments. The disk storage 1114 can include an interactive timeline module 1146 configured to track user progress in learning a new language. The disk storage 1114 can also include a contextual builder module 1148 configured to provide language support for specially-abled individuals. For example, the contextual builder module 1148 can be configured to extract base phonetics for a specially-abled user and detect one or more gaps in sentences when speaking or writing. In some examples, the contextual builder module 1148 may then automatically fill the gaps based on the set of base phonetics so that the specially-abled user can easily interact with others in their own languages. For example, a user with a special ability related to Broca's Aphasia may want to express something but not be able to express or directly communicate the thought or idea to another user. The contextual builder 1148 may determine the thought or idea to be expressed using the base phonetics of the specially-abled user and translate the expression of the thought or idea into the language of another user accordingly.

In some examples, some or all of the processes performed for extracting base phonetics or detecting emotional states can be performed in a cloud service and reloaded on the client computer of the user. For example, some or all of the applications described above for presenting educational activities could be running in a cloud service and receiving input from a user through a client computer.

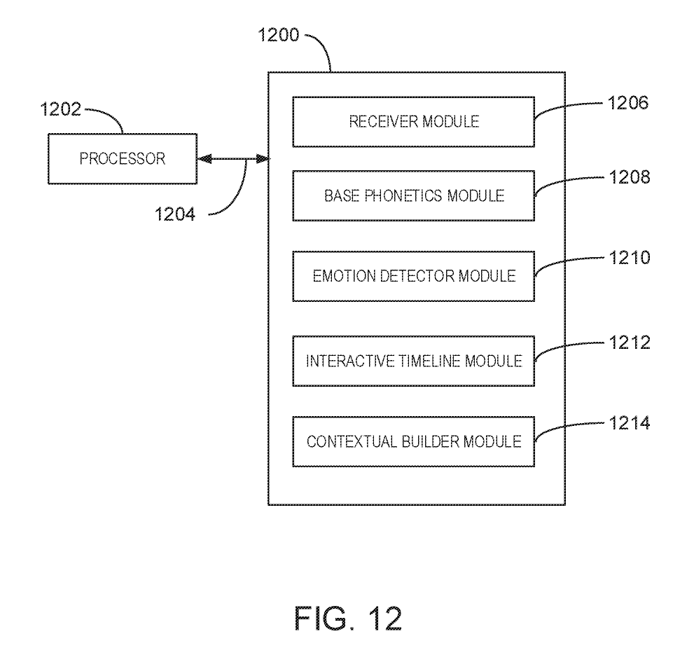

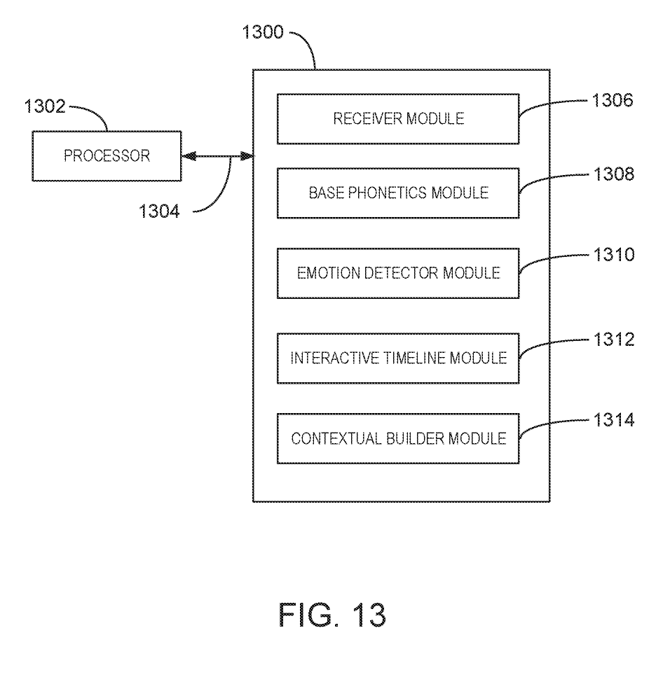

FIG. 12 is a block diagram showing computer-readable storage media 1200 that can store instructions for presenting educational activities. The computer-readable storage media 1200 may be accessed by a processor 1202 over a computer bus 1204. Furthermore, the computer-readable storage media 1200 may include code to direct the processor 1202 to perform steps of the techniques disclosed herein.

The computer-readable storage media 1200 can include code such as a receiver module 1206 configured to receive a voice recording associated with a user. A base phonetics module 1208 can be configured to extract base phonetics from the received voice recording to generate a set of base phonetics corresponding to the user. In some examples, the base phonetics module 1308 may also be configured to provide the extracted base phonetics and receive a second set of base phonetics in response to detecting a tap and share gesture. For example, the tap and share gesture may use NFC technology to swap base phonetics with another device. An emotion detector module 1210 can be configured to interact with the user in a style or dialect of the user based on the set of base phonetics. For example, the emotion detector 1210 can interact with the user based on a detected emotional state of the user. In some examples, the emotion detector module 1210 can be configured to respond to a user with a predetermined voice based on the detected emotional state of the user. For example, the emotional detector module 1210 may respond with one voice if the user has a low detected emotion state and a different voice if the user has a normal emotional state.

Further, the computer-readable storage media 1200 can include an interactive timeline module 1212 configured to provide a timeline to a user to track progress in learning a language. For example, the interactive timeline 1212 can be configured to provide a user with adjustable goals for learning a new language based on the user's set of base phonetics.

The computer-readable storage media 1200 can also include a contextual builder module 1214 configured to fill in gaps in speech for the user. For example, the user may be a specially-abled user. In some examples, the contextual builder module 1214 can receive a voice recording from a specially-abled user and translate the voice recording by filling in gaps based on the set of base phonetics of the specially-abled user.

It is to be understood that any number of additional software components not shown in FIG. 12 may be included within the computer-readable storage media 1200, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

### EXAMPLE 1

This example provides for an example system for linguistic modeling. The example system includes a computer processor and a computer-readable memory storage device storing executable instructions that can be executed by the processor to cause the processor to receive a voice recording associated with a user. The executable instructions can be executed by the processor to extract base phonetics from the received voice recording to generate a set of base phonetics corresponding to the user. The executable instructions can be executed by the processor to interact with the user in a style or dialect of the user based on the set of base phonetics corresponding to the user. Alternatively, or in addition, the processor can receive additional voice recordings associated with the user and update the set of base phonetics. Alternatively, or in addition, the received voice recording can include words generated on a daily basis from a daily routine of the user. Alternatively, or in addition, interacting with the user can include responding to the user using a voice that is based on the set of base phonetics. Alternatively, or in addition, the base phonetics can include voice attributes and voice parameters. Alternatively, or in addition, the processor can perform phonetics benchmarking on the base phonetics and determine a plurality of thresholds associated with the set of base phonetics. Alternatively, or in addition, the processor can detect a user emotion based on a detected emotional state and interact with the user in a predetermined voice based on the detected user emotion. Alternatively, or in addition, the processor can fill in gaps of speech for the user based on a detected context and the set of base phonetics.

### EXAMPLE 2

This example provides for an method for linguistic modeling. The example method includes receiving a voice recording associated with a user. The method also includes extracting base phonetics from the received voice recording to generate a set of base phonetics corresponding to the user. The method further also includes interacting with the user in a style or dialect of the user based on the set of base phonetics corresponding to the user. Alternatively, or in addition, interacting with the user can include providing auditory feedback in the user's voice based on the set of base phonetics. Alternatively, or in addition, interacting with the user can include generating a language learning plan based on a home language and home culture of the user and providing auditory feedback to the user in a language to be learned. Alternatively, or in addition, interacting with the user can include providing an interactive timeline for the user to track progress in learning a new language. Alternatively, or in addition, interacting with the user can include translating a user's voice input into a second language based on a received set of base phonetics of another user. Alternatively, or in addition, interacting with the user can include providing auditory feedback to a user in a selected favorite voice from a preconfigured set of favorite voices. The favorite voices include voices of friends or relatives. Alternatively, or in addition, interacting with the user can include generating a customized language learning plan based on the set of base phonetics and a selected language to be learned. Alternatively, or in addition, interacting with the user can include multi-lingual context switching. For example, the multi-lingual context switching can include translating a received voice recording from a second user or more than one user into a voice of the user based on a received second set of base phonetics and playing back the translated voice recording. Alternatively, or in addition, interacting with the user can include detecting an emotional state of the user and providing auditory feedback in a voice based on the detected emotional state.

### EXAMPLE 3

This example provides for an example computer-readable storage device for linguistic modeling. The example computer-readable storage device includes executable instructions that can be executed by a processor to cause the processor to receive a voice recording associated with a user. The executable instructions can be executed by the processor to extract base phonetics from the received voice recording to generate a set of base phonetics corresponding to the user. The executable instructions can be executed by the processor to interact with the user in a style or dialect of the user based on the set of base phonetics corresponding to the user. Alternatively, or in addition, the executable instructions can be executed by the processor to receive a second set of base phonetics and translate input from the user into another language based on the second set of base phonetics. Alternatively, or in addition, the executable instructions can be executed by the processor to provide the extracted base phonetics and receive a second set of base phonetics in response to detecting a tap and share gesture.

### EXAMPLE 4

This example provides for an example system for linguistic modeling. The example system includes means for receiving a voice recording associated with a user. The system may also include means for extracting base phonetics from the received voice recording to generate a set of base phonetics corresponding to the user. The system may also include means for interacting with the user in a style or dialect of the user based on the set of base phonetics corresponding to the user. Alternatively, or in addition, the means for receiving a voice recording can receive additional voice recordings associated with the user and update the set of base phonetics. Alternatively, or in addition, the received voice recording can include words generated on a daily basis from a daily routine of the user. Alternatively, or in addition, interacting with the user can include responding to the user using a voice that is based on the set of base phonetics. Alternatively, or in addition, the base phonetics can include voice attributes and voice parameters. Alternatively, or in addition, the means for extracting base phonetics can perform phonetics benchmarking on the base phonetics and determine a plurality of thresholds associated with the set of base phonetics. Alternatively, or in addition, the system can include means for detecting a user emotion based on a detected emotional state and interact with the user in a predetermined voice based on the detected user emotion. Alternatively, or in addition, the system can include means for fill in gaps of speech for the user based on a detected context and the set of base phonetics.

What has been described above includes examples of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the disclosed subject matter. In this regard, it will also be recognized that the innovation includes a system as well as a computer-readable storage media having computer-executable instructions for performing the acts and events of the various methods of the disclosed subject matter.

There are multiple ways of implementing the disclosed subject matter, e.g., an appropriate API, tool kit, driver code, operating system, control, standalone or downloadable software object, etc., which enables applications and services to use the techniques described herein. The disclosed subject matter contemplates the use from the standpoint of an API (or other software object), as well as from a software or hardware object that operates according to the techniques set forth herein. Thus, various implementations of the disclosed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the disclosed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for linguistic modeling, comprising:
a processor; and
a computer memory, comprising instructions that cause the processor to:
receive a voice recording associated with a user;
extract base phonetics from the received voice recording to generate a set of base phonetics corresponding to the user; and
interact with the user in a style or dialect of the user based on the set of base phonetics corresponding to the user.

2. The system of claim 1, wherein the processor is to receive additional voice recordings associated with the user and update the set of base phonetics.

3. The system of claim 1, wherein the received voice recording comprises words generated on a daily basis from a daily routine of the user.

4. The system of claim 1, wherein interacting with the user comprises responding to the user using a voice that is based on the set of base phonetics.

5. The system of claim 1, wherein the base phonetics comprise voice attributes and voice parameters.

6. The system of claim 1, wherein the processor is to perform phonetics benchmarking on the base phonetics and determine a plurality of thresholds associated with the set of base phonetics.

7. The system of claim 1, wherein the processor is to detect a user emotion based on a detected emotional state and interact with the user in a predetermined voice based on the detected user emotion.

8. The system of claim 1, wherein the processor is to fill in gaps of speech for the user based on a detected context and the set of base phonetics.

9. A method for linguistic modeling, comprising:
receiving a voice recording associated with a user;
extracting base phonetics from the received voice recording to generate a set of base phonetics corresponding to the user; and
interacting with the user in a style or dialect of the user based on the set of base phonetics corresponding to the user.

10. The method of claim 9, wherein interacting with the user comprises providing auditory feedback in the user's voice based on the set of base phonetics.

11. The method of claim 9, wherein interacting with the user comprises generating a language learning plan based on a home language and home culture of the user and providing auditory feedback to the user in a language to be learned.

12. The method of claim 9, wherein interacting with the user comprises providing an interactive timeline for the user to track progress in learning a new language.

13. The method of claim 9, wherein interacting with the user comprises translating a user's voice input into a second language based on a received set of base phonetics of another user.

14. The method of claim 9, wherein interacting with the user comprises providing auditory feedback to a user in a selected favorite voice from a preconfigured set of favorite voices, wherein the favorite voices comprise voices of friends or relatives.

15. The method of claim 9, wherein interacting with the user comprises generating a customized language learning plan based on the set of base phonetics and a selected language to be learned.

16. The method of claim 9, wherein interacting with the user comprises multi-lingual context switching, wherein multi-lingual context switching comprises translating a received voice recording from a second user or more than one user into a voice of the user based on a received second set of base phonetics and playing back the translated voice recording.

17. The method of claim 9, wherein interacting with the user comprises detecting an emotional state of the user and providing auditory feedback in a voice based on the detected emotional state.

18. A computer-readable storage device for linguistic modeling, comprising instructions that cause a computer processor to:
receive a voice recording associated with a user;
extract base phonetics from the received voice recording to generate a set of base phonetics corresponding to the user; and
interact with the user in a style or dialect of the user based on the set of base phonetics corresponding to the user.

19. The computer-readable storage device of claim 18, comprising instructions that cause the computer to receive a second set of base phonetics and translate input from the user into another language based on the second set of base phonetics.

20. The computer-readable storage device of claim 18, comprising instructions that cause the computer to provide the extracted base phonetics and receive a second set of base phonetics in response to detecting a tap and share gesture.
